(19) United States
(12) Patent Application Publication
(10) Pub. No.: US 2026/0273823 A1
(43) Pub. Date: Sep. 17, 2026

(54) MACHINE DIRECTION ORIENTED POLYETHYLENE FILMS FOR LABELS AND RELATED METHODS

(71) Applicant: ExxonMobil Chemical Patents Inc., Spring, TX (US)

(72) Inventors: Si Qi FAN, Shanghai (CN); Kai WANG, Shanghai (CN); Ying ZOU, Shanghai (CN)

(21) Appl. No.: 18/874,014

(22) PCT Filed: May 24, 2023
(86) PCT No.: PCT/US2023/067408

§ 371 Date: Dec. 11, 2024

Related U.S. Application Data
(60) Provisional application No. 63/366,349, filed on Jun. 14, 2022.

(51) Int. Cl. B29C 48/00; B29C 48/10; B29C 48/21; B29K 23/00; B32B 7/02; B32B 27/08; B32B 27/32; C08L 23/06; C08L 23/0807; C08L 23/16

(52) U.S. Cl. CPC B29C 48/022; B29C 48/10; B29C 48/21; B32B 7/02; B32B 27/08; B32B 27/32; C08L 23/06; C08L 23/0815; C08L 23/16; B29K 2023/0625; B29K 2023/065; B29K 2023/08; B32B 2307/72; C08L 2203/16; C08L 2205/025; C08L 2314/06

(57) ABSTRACT

Machine direction oriented polyethylene films may be useful as the face stock material of labels. A nonlimiting oriented film may include: a first layer comprising a long chain branched metallocene linear low density polyethylene (LCB-mLLDPE); a second layer comprising a high density polyethylene; a third layer comprising 0 wt % to about 90 wt % of a metallocene linear low densitypoly-ethylene (mLLDPE) and about 10 wt % to 100 wt % of an ethylene-based elastomer and/or a propylene-based elastomer, wherein the third layer does not form a surface of the oriented film; wherein the oriented film has a polyethylene content of about 90 wt % or greater; and wherein the oriented film has a uniaxial, machine orientation.

### CROSS-REFERENCE TO RELATED APPLICATION

This application claims the benefit of U.S. Provisional Application 63/366,349 filed Jun. 14, 2022, entitled “MACHINE DIRECTION ORIENTED POLYETHYLENE FILMS FOR LABELS AND RELATED METHODS”, the entirety of which is incorporated by reference herein.

### FIELD OF INVENTION

The present application relates to polyethylene films suitable for use as the face stock material of labels and methods of producing said polyethylene films.

### BACKGROUND

In many label applications, it is desirable that the face stock from which the labels are cut from a film of polymeric material rather than paper. Polymeric film can provide properties lacking in paper, such as durability, strength, water resistance, abrasion resistance, gloss, transparency, and other properties.

The polymeric films used to produce face stock for labels should have enough “give” or flexibility to conform well to the substrates or containers on which said label are used (a particularly demanding requirement when the labels are applied to flexible substrates such as squeezable plastic containers, for example shampoo bottles and condiment containers, but also a requirement with respect to rigid substrates which may have irregularities in their surfaces, such as glass bottles). On the other hand, labels cut from the film should be sufficiently dimensionally stable to maintain print registration and stiff enough to allow them to be properly dispensed as an in-mold label, or to dispense properly past a peel plate or peel-back edge, over which the liner or carrier is stripped, at speeds which are high enough to be commercially viable.

Polyethylene is a polymer commonly used in face stock material of labels, especially in home personal care and chemical bottles because of conformability and environmental resistance. Currently, the market is seeing a shift towards seeking thinner label solutions, which is, in part, sustainability driven. Typically commercial thickness for polyethylene films used as face stock for labels is about 80 μm to about 85 μm. Attempts to down-gauge further have been shown to reduce stiffness properties for the face stock, thus potentially leading to poor cut-ability or dimensional stability in the post conversion process.

### SUMMARY OF INVENTION

The present application relates to polyethylene films suitable for use as the face stock material of labels and methods of producing said polyethylene films.

A nonlimiting example method of the present disclosure comprises: blowing a film comprising a first layer, a second layer, and a third layer, wherein the first layer comprises a long chain branched metallocene linear low density polyethylene (LCB-mLLDPE), wherein the second layer comprises a high density polyethylene, and wherein the third layer comprises 0 wt % to about 90 wt % of a metallocene linear low density polyethylene (mLLDPE) and about 10 wt % to 100 wt % of an ethylene-based elastomer and/or a propylene-based elastomer; blocking the film with the third layer as a blocking layer to yield a blocked film; and orienting the blocked film in a machine direction to produce an oriented film, wherein the oriented film has a polyethylene content of about 90 wt % or greater.

A nonlimiting example oriented film of the present disclosure comprises: a first layer comprising a long chain branched metallocene linear low density polyethylene (LCB-mLLDPE); a second layer comprising a high density polyethylene; a third layer comprising 0 wt % to about 90 wt % of a metallocene linear low density polyethylene (mLLDPE) and about 10 wt % to 100 wt % of an ethylene-based elastomer and/or a propylene-based elastomer, wherein the third layer does not form a surface of the oriented film; wherein the oriented film has a polyethylene content of about 90 wt % or greater; and wherein the oriented film has a uniaxially, machine orientation.

A nonlimiting example method of the present disclosure comprises: blowing a film comprising a first layer and a second layer, wherein the first layer comprises a long chain branched metallocene linear low density polyethylene (LCB-mLLDPE) and/or a high density polyethylene, and wherein the second layer comprises 0 wt % to about 90 wt % of a metallocene linear low density polyethylene (mLLDPE) and about 10 wt % to 100 wt % of an ethylene-based elastomer and/or a propylene-based elastomer; blocking the film with the second layer as a blocking layer to yield a blocked film; and orienting the blocked film in a machine direction to produce an oriented film, wherein the oriented film has a polyethylene content of about 90 wt % or greater.

A nonlimiting example oriented film of the present disclosure comprises: a first layer comprising a long chain branched metallocene linear low density polyethylene (LCB-mLLDPE) and/or a high density polyethylene; a second layer comprising 0 wt % to about 90 wt % of a metallocene linear low density polyethylene (mLLDPE) and about 10 wt % to 100 wt % of an ethylene-based elastomer and/or a propylene-based elastomer, wherein the second layer does not form a surface of the oriented film; wherein the oriented film has a polyethylene content of about 90 wt % or greater; and wherein the oriented film has a uniaxially, machine orientation.

These and other features and attributes of the disclosed compositions and methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1A illustrates a nonlimiting example of a method of the present disclosure.

FIGS. 1B-1D illustrate nonlimiting example film compositions corresponding to the method of FIG. 1A.

FIG. 2 is a graph illustrating VGP (Van Gurp Palmen) curves for certain commercial examples of suitable metallocene-catalyzed LLDPE with some long-chain branching, as described herein.

### DETAILED DESCRIPTION

The present application relates to polyethylene films suitable for use as the face stock material of labels and methods of producing said polyethylene films. More specifically, the methods of the present disclosure include blowing and blocking processes to produce a thicker, multilayer film that can then be uniaxially oriented (e.g. via stretching) in the machine direction. The resultant oriented films, which may be 70 μm thick or less may be used in producing labels.

By using layers, each layer may improve desirable properties to the final label product. Further, the uniaxial orientation may enhance at least some of the mechanical properties, which may allow for the production of down-gauged labels with improved properties.

Further, the compositions and methods of the present disclosure produce oriented films with improved optical properties (e.g., greater clarity and less haze).

### Definitions and Test Methods

Unless otherwise indicated, room temperature is 25° C.

An “olefin,” alternatively referred to as “alkene,” is a linear, branched, or cyclic compound of carbon and hydrogen having at least one double bond.

A “polymer” has two or more of the same or different mer units. A “homopolymer” is a polymer having mer units that are the same. The term “polymer” as used herein includes, but is not limited to, homopolymers, copolymers, terpolymers, etc. The term “polymer” as used herein also includes impact, block, graft, random, and alternating copolymers. The term “polymer” shall further include all possible geometrical configurations unless otherwise specifically stated. Such configurations may include isotactic, syndiotactic, and random symmetries.

As used herein, unless specified otherwise, the term “copolymer(s)” refers to polymers formed by the polymerization of at least two different monomers (i.e., mer units). For example, the term “copolymer” includes the copolymerization reaction product of propylene and an alpha-olefin, such as ethylene, 1-hexene. A “terpolymer” is a polymer having three mer units that are different from each other. Thus, the term “copolymer” is also inclusive terpolymers and tetrapolymers, such as, for example, the copolymerization product of a mixture of ethylene, propylene, 1-hexene, and 1-octene.

“Different” as used to refer to monomer mer units indicates that the mer units differ from each other by at least one atom or are different isomerically. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on. For purposes of this disclosure, a polyethylene is an ethylene polymer.

As used herein, when a polymer is referred to as “comprising, consisting of, or consisting essentially of” a monomer, the monomer is present in the polymer in the polymerized/derivative form of the monomer. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer.

Density, reported in g/cm³, is determined in accordance with ASTM D792-20 (the plaque is and molded according to ASTM D4703-10a, procedure C, plaque preparation, including that the plaque is conditioned for at least forty hours at 23° C. to approach equilibrium crystallinity). Briefly, the mass of a specimen of the solid plastic is measured in air. The specimen is then immersed in a liquid, where the specimen's apparent mass upon immersion is determined and specific gravity (relative density) is calculated.

As used herein, Mn is number average molecular weight, Mw is weight average molecular weight, and Mz is z-average molecular weight. Molecular weight distribution (MWD) is defined to be Mw divided by Mn. Unless otherwise noted, all molecular weights (e.g., Mw, Mn, Mz) are reported in units of g/mol.

For polyethylene compositions, molecular weight values are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10 μm Mixed-B LS columns are used to provide polymer separation. Detailed analytical principles and methods for molecular weight determinations and g′(vis) are described in paragraphs [0044]-[0051] of PCT Publication WO2019/246069A1, which are incorporated herein by reference (noting that the equation c=///referenced in Paragraph therein for concentration (c) at each point in the chromatogram, is c=βI, where β is mass constant and I is the baseline-subtracted IR5 broadband signal intensity (I)). Unless specifically mentioned, all the molecular weight moments used or mentioned in the present disclosure are determined according to the conventional molecular weight (IR molecular weight) determination methods (e.g., as referenced in Paragraphs [0044]-[0051] of the just-noted publication), noting that for the equation in such Paragraph [0044], α=0.695 and K=0.000579 (1-0.75Wt) are used, where Wt is the weight fraction for comonomer, and further noting that comonomer composition is determined by the ratio of the IR5 detector intensity corresponding to CH₂ and CH₃ channel calibrated with a series of PE and PP homo/copolymer standards whose nominal values are predetermined by NMR or FTIR (providing methyls per 1000 total carbons (CH₃/1000 TC)) as noted in Paragraph of the just-noted PCT publication). Other parameters needed can be found in the referenced passage in the WO2019/246069A1 publication, but some are included here for convenience: n=1.500 for 1,2,4 trichlorobenzene (TCB) at 145° C.; I=665 nm; dn/dc=0.1048 ml/mg.

For polypropylene elastomer compositions, molecular weight values are determined using a High Temperature Size Exclusion Chromatograph (SEC) (either from Waters Corporation or Polymer Laboratories), equipped with a differential refractive index detector (DRI), an online light scattering (LS) detector, and a viscometer. Three Polymer Laboratories PLgel 10 mm Mixed-B columns are used. The nominal flow rate is 0.5 cm³/min, and the nominal injection volume is 300 μL. The various transfer lines, columns and differential refractometer (the DRI detector) are contained in an oven maintained at 145° C. Polystyrene is used to calibrate the instrument. Solvent for the SEC experiment is prepared by dissolving 6 g of butylated hydroxy toluene as an antioxidant in 4 L of Aldrich reagent grade TCB. The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for hours. All quantities are measured gravimetrically. The TCB densities used to express the polymer concentration in mass/volume units are 1.463 g/mL at room temperature and 1.324 g/mL at 135° C. The injection concentration ranges from 1.0 mg/mL to 2.0 mg/mL, with lower concentrations being used for higher molecular weight samples. Prior to running each sample, the DRI detector and the injector are purged. Flow rate in the apparatus is then increased to 0.5 mL/min, and the DRI is allowed to stabilize for 8-9 hours before injecting the first sample. The LS laser is turned on 1 hour to 1.5 hours before running samples. The concentration, c, at each point in the chromatogram is calculated from the baseline-subtracted DRI signal, IDRI, using the following equation:

$$c = {K}_{DRI} {I}_{DRI} / ( dn / dc )$$

where K_{DRI} is a constant determined by calibrating the DRI, and dn/dc is the same as described below for the LS analysis. Units on parameters throughout this description of the SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, Light Scattering from Polymer Solutions, Academic Press, 1971):

$$[ \frac{{K}_{o} c}{Δ R ( θ , c )} ] = [ \frac{1}{MP ( θ )} ] + 2 {A}_{2} c$$

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and Kₒ is the optical constant for the system:

$${K}_{o} = \frac{4 {π}^{2} {{n}^{2} ( dn / dc )}^{2}}{{λ}^{4} {N}_{A}}$$

where N_{A} is the Avogadro's number, and dn/dc is the refractive index increment for the system. The refractive index, n=1.500 for TCB at 135° C. and λ=690 nm. In addition, A2=0.0015 and dn/dc=0.104 for ethylene polymers, whereas A2=0.0006 and dn/dc=0.104 for propylene polymers.

The molecular weight averages are usually defined by considering the discontinuous nature of the distribution in which the macromolecules exist in discrete fractions i containing Nᵢ molecules of molecular weight Mᵢ. The weight-average molecular weight, M_{w}, is defined as the sum of the products of the molecular weight Mᵢ of each fraction multiplied by its weight fraction wᵢ:

$${M}_{w} ≡ \sum {w}_{i} {M}_{i} = ( \frac{\sum {N}_{i} {M}_{i}^{2}}{\sum {N}_{i} {M}_{i}} )$$

since the weight fraction wᵢ is defined as the weight of molecules of molecular weight Mᵢ divided by the total weight of all the molecules present:

$${w}_{i} = \frac{{N}_{i} {M}_{i}}{\sum {N}_{i} {M}_{i}}$$

The number-average molecular weight, Mₙ, is defined as the sum of the products of the molecular weight Mᵢ of each fraction multiplied by its mole fraction xᵢ:

$${M}_{n} ≡ \sum {x}_{i} {M}_{i} = ( \frac{\sum {N}_{i} {M}_{i}}{\sum {N}_{i}} )$$

since the mole fraction xᵢ is defined as Nᵢ divided by the total number of molecules:

$${x}_{i} = \frac{{N}_{i}}{\sum {N}_{i}}$$

In the SEC, a high temperature Viscotek Corporation viscometer is used, which has four capillaries arranged in a Wheatstone Bridge configuration with two pressure transducers. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

$${η}_{s} = c [ η ] + 0.3 {( c [ η ] )}^{2}$$

where c is determined from the DRI output.

The branching index (g′, also referred to as g′(vis)) is calculated using the output of the SEC-DRI-LS-VIS method as follows. The average intrinsic viscosity, [η]_{avg}, of the sample is calculated by:

$${η}_{avg} = \frac{\sum {{c}_{i} [ η ]}_{i}}{\sum {c}_{i}}$$

where the summations are over the chromatographic slices, i, between the integration limits.

The DSC run setting is performed with PerkinElmer's DSC 8000. Peak melting point or melting temperature (Tₘ), peak crystallization temperature or crystallization temperature (T_{c}) and heat of fusion or heat flow (ΔH_{f} or H_{f}) are determined using the following DSC procedure. Samples weighing approximately 5 mg are carefully sealed in aluminum hermetic pan. Heat flow is normalized with the sample mass. The material is held at −20° C. for 5 min and then the material is ramped up from −20° C. at 10° C./min to 200° C., after equilibration (3 min at 200° C.), the samples are cooled down at 10° C./min to −20° C. and equilibrate for 5 min. After the cooling process where the T_{c} is determined, a second melting process is performed to determine the Tₘ. Once again the material is heated from −20° C. at 10° C./min up to 200° C. The melting (Tₘ) and crystallization (T_{c}) peak temperatures are calculated by integrating the peak position over a temperature range which well-included the peak (baseline).

Melt flow index (MFI) is measured according to ASTM 1238-13 on a Goettfert MI-4 Melt Indexer. Testing conditions are set at 190° C. and 2.16 kg load for polyethylene and 230° C. and 2.16 kg load for polypropylene (unless otherwise specified). An amount of 5 g to 6 g of sample is loaded into the barrel of the instrument at 190° C. and manually compressed. Afterwards, the material is automatically compacted into the barrel by lowering all available weights onto the piston to remove all air bubbles. Data acquisition is started after a 6 min pre-melting time. Also, the sample is pressed through a die of 8 mm length and 2.095 mm diameter.

Vicat softening temperature may be measured according to ASTM D152517-e1.

As used herein, the terms “machine direction” and “MD” refer to the orientation (or stretch) direction in the plane of the film.

As used herein, the terms “transverse direction” and “TD” refer to the perpendicular direction in the plane of the film relative to the MD.

Gauge (or thickness) of a film should be determined by ASTM D6988-13, and is expressed in μm unless otherwise specified.

Clarity can be determined by ASTM D1476-09.

Haze can be determined by ASTM D1003-13.

Gloss can be determined by ASTM D2457-13.

Bending stiffness factor can be determined by DIN 53121:2014-08.

Machine direction force at 1% strain, machine direction force at break, and machine direction elongation can be determined by ASTM D882-18.

### Films and Related Methods

The films of the present disclosure may be prepared by blowing a multilayer film, blocking the multilayer film, and orienting the multilayer film in the machine direction.

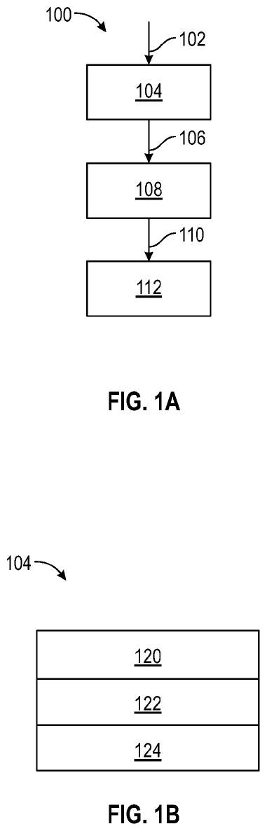

FIG. 1A illustrates a nonlimiting example of a method 100 of the present disclosure, and FIGS. 1B-1D illustrate nonlimiting example film compositions corresponding to the method 100. The method 100 includes blowing 102 a film 104 comprising a first layer 120, a second layer 122, and a third layer 124, wherein the first, second, and third layers 120, 122, and 124 have different compositions. The film 104 is then blocked 106 so that the third layer 124 is adhered to itself to produce a blocked film 108 having the structure, in order, of: the first layer 120, the second layer 122, the third layer 124′ (i.e., the third layer 124 blocked to another third layer 124), the second layer 122, and the first layer 120. The blocked film 108 is then uniaxially oriented 110 in the machine direction (MD) to produce a machine direction oriented (MDO) film 112 where each layer 120, 122, and 124′ of the blocked film 108 is a thinner layer 120″, 122″, and 124″ thereof, for example as illustrated in FIG. 1C.

The method 100 and structures 104, 108, and 112 of FIGS. 1A-1D may be adapted to films with other numbers of layers including after the blowing process films having 2 layers to 10 layers (or 2 layers to 5 layers, or 4 layers to 10 layers), which produces after the blocking and orienting processes films having 3 layers to 19 layers (or 3 layers to 9 layers, or 7 layers to 19 layers).

The layer of the blown film that is blocked together (also referred to herein as a “blocking layer”) may comprise 0 wt % to about 90 wt % of a metallocene linear low density polyethylene (mLLDPE) and about 10 wt % to 100 wt % of an ethylene-based elastomer and/or a propylene-based elastomer. Advantageously, low density elastomers may provide the adhesion in the blocking process. Preferably, components, and especially polymeric components, other than the mLLDPE and/or propylene-based elastomer are substantially absent from the blocking layer—that is, the blocking layer may consist or consist essentially of the mLLDPE and/or propylene-based elastomer (wherein “consist essentially of” allows for additives or impurities, including polymeric additives, so long as they are used in small amounts typical to additives (e.g., 5 wt % or less, preferably 1 wt % or less, more preferably 0.5 wt % or less, on basis of mass of the layer)). In certain embodiments, polymeric components other than the mLLDPE and/or propylene-based elastomer are entirely absent from the blocking layer; and optionally, the blocking layer may consist of the mLLDPE and/or propylene-based elastomer, such that other polymeric components and additives are both absent from such layer.

Layers that are not the layer undergoing blocking (also referred to herein as “nonblocking layers”) may comprise long-chain-branched metallocene linear low density polyethylene (LCB-mLLDPE) and/or high density polyethylene. Preferably, one or more of the layers that are not the layer undergoing blocking comprise, consist, or consist essentially of LCB-mLLDPE and/or high density polyethylene (again, where “consist essentially of” allows for impurities on the order of 1,000 ppm or less, preferably 100 ppm or less, such as 10 ppm or less; and optional additives at 5 wt % or less, preferably 1 wt % or less, preferably 0.5 wt % or less; said ppm and wt % on basis of mass of the layer in question). By way of nonlimiting example, FIG. 1D may comprise a first layer 120″ comprising (or consisting of, or consisting essentially of) a LCB-mLLDPE, a second layer 122″ comprising (or consisting of, or consisting essentially of) a high density polyethylene, and a third layer 124″ comprising (or consisting of, or consisting essentially of) 0 wt % to about 90 wt % of a metallocene linear low density polyethylene (mLLDPE) and about 10 wt % to 100 wt % of an ethylene-based elastomer and/or a propylene-based elastomer. In another nonlimiting example, FIG. 1D may comprise a first layer 120″ comprising (or consisting of, or consisting essentially of) a high density polyethylene, a second layer 122″ comprising (or consisting of, or consisting essentially of) a LCB-mLLDPE, and a third layer 124″ comprising (or consisting of, or consisting essentially of) 0 wt % to about 90 wt % of a mLLDPE and about 10 wt % to 100 wt % of a propylene-based elastomer. In yet another nonlimiting example, FIG. 1D may comprise a first layer 120″ comprising (or consisting of, or consisting essentially of) a blend of LCB-mLLDPE and high density polyethylene, a second layer 122″ comprising (or consisting of, or consisting essentially of) a LCB-mLLDPE, and a third layer 124″ comprising (or consisting of, or consisting essentially of) 0 wt % to about 90 wt % of a metallocene linear low density polyethylene (mLLDPE) and about 10 wt % to 100 wt % of an ethylene-based elastomer and/or a propylene-based elastomer. In another nonlimiting example, FIG. 1D may comprise a first layer 120″ comprising (or consisting of, or consisting essentially of) a LCB-mLLDPE, a second layer 122″ comprising (or consisting of, or consisting essentially of) a blend of LCB-mLLDPE and high density polyethylene, and a third layer 124″ comprising (or consisting of, or consisting essentially of) 0 wt % to about 90 wt % of a metallocene linear low density polyethylene (mLLDPE) and about 10 wt % to 100 wt % of an ethylene-based elastomer and/or a propylene-based elastomer. The composition of the surface nonblocking layer after blowing the film (e.g., the first layer 120 of FIG. 1) may be chosen to allow for effective printing thereon after the orienting process.

Without being limited by theory, it is believed that the inclusion of layers comprising (or consisting of, or consisting essentially of) LCB-mLLDPE and/or high density polyethylene impart strength and rigidity to the blocked film. Then, the MD orientation of the blocked film down-gauges said film to a desired thickness and may also further improve mechanical properties of the film while maintaining desired optical properties of the film.

Blocking layers above were noted to comprise 0 to 90 wt % mLLDPE and 10 to 100 wt % ethylene-based elastomer and/or propylene-based elastomer; however, in the various embodiments herein, different endpoints for each of these ranges (i.e., different relative blend amounts) of each component are contemplated. For example, a blocking layer may comprise (or consist of, or consist essentially of):
the mLLDPE in a range from a low of any one of 0, 1, 2, 3, 4, 5, 10, 15, 20, 25, 30, 40, 50, 60, 70, or 80 wt % to a high of any one of 10, 20, 25, 30, 40, 50, 60, 70, 75, 80, 85, or 90 wt %, with ranges from any of the foregoing low ends to any of the foregoing high ends contemplated herein, provided the high end is greater than the low end (e.g., 0 to 90 such as 0 to 50 wt %, or 25 to 75 wt %, or 50 to 80 wt %, or 70 to 90 wt %, etc.); and
the ethylene-based and/or propylene-based elastomer in a range from a low of any one of about 10, 15, 20, 25, 30, 40, 50, 60, 70, 75, 80, or 90 wt % to a high of any one of about 20, 30, 40, 50, 60, 70, 75, 80, 85, 90, 95, 96, 97, 98, 99, or 100 wt %, again with ranges from any foregoing low to any foregoing high contemplated (provided the high end is greater than the low end), e.g., 10 to 100 wt % or 50 to 100 wt % or 25 to 75 wt %, 20 to 50 wt % or 10 to 30 wt %, etc. Preferably, when a propylene-based elastomer is used, the propylene-based elastomer is present at not more than about 50 wt % (or about 5 wt % to about 50 wt %, or about 5 wt % to about 30 wt %, or about 20 wt % to about 50 wt %) of the blocking layer (or any other range among those discussed above, up to 50 wt %). mLLDPE and elastomer compositions are discussed further herein. The wt % s discussed are on basis of the blocking layer.

Nonblocking layers may comprise (or consist of, or consist essentially of) a LCB-mLLDPE, high density polyethylene, or a blend of a LCB-mLLDPE and a high density polyethylene. Nonblocking layers may comprise about 90 wt % or greater (about 90 wt % to 100 wt %, or about 90 wt % to about 99 wt %, or about 90 wt % to about 95 wt %) of the LCB-mLLDPE, the high density polyethylene, or the blend thereof. When used in a blend, a weight ratio of the LCB-mLLDPE to the high density polyethylene may be about 99:1 to about 1:99 (or about 99:1 to about 50:50, or about 75:25 to about 25:75, or about 50:50 to about 1:99). LCB-mLLDPE and high density polyethylene composition are discussed further herein. The wt % and ratios discussed are on basis of the respective nonblocking layer in question.

The oriented films of the present disclosure may have a polyethylene content of about 90 wt % or greater (or about 90 wt % to 100 wt %, or about 90 wt % to about 99 wt %, or about 95 wt % to 100 wt %, or about 95 wt % to about 99 wt %, or about 97 wt % to 100 wt %, or about 97 wt % to about 99 wt %) based on a total weight of the oriented film.

The oriented films of the present disclosure may have a cumulative amount of LCB-mLLDPE and high density polyethylene of about 70 wt % or greater (or about 70 wt % to 95 wt %, or about 70 wt % to about 80 wt %, or about 75 wt % to 85 wt %, or about 80 wt % to about 90 wt %, or about 85 wt % to 95 wt %) based on a total weight of the oriented film.

The blocked films of the present disclosure may have a thickness of about 200 μm to about 450 μm (or about 200 μm to about 275 μm, or about 250 μm to about 325 μm, or about 275 μm to about 350 μm, or about 300 μm to about 450 μm).

Orienting the blocked films of the present disclosure may comprise: stretching the film at a temperature below the melting temperature of the any polymers within the blocked film. Stretching may be achieved by threading the film through a series of rollers where the temperature and speed of the individual rollers are controlled to achieve a desired film thickness and the stretch ratio. Typically, this series of rollers. Examples of rollers that may be used during orienting may include, but are not limited to, pre-heat rollers, various stretching stages with or without annealing rollers between stages, one or more conditioning and annealing rollers, and one or more chill rollers. Orienting the film may be accomplished by inducing a speed differential between two or more adjacent rollers.

The stretch ratio may be used to describe the degree of orienting of the film. The stretch ratio is the speed of the fast roller divided by the speed of the slow roller. For example, orienting a film using an apparatus where the slow roller speed is 1 m/min and fast roller speed is 7 m/min means the stretch ratio is 7 (also referred to herein as 7 times or 7×). The physical amount of stretching of the film is close to but not exactly the stretch ratio because relaxation of the film may occur after orienting, although typically only to a marginal extent.

Greater stretch ratios result in thinner films with greater orientation in the MD. The stretch ratio when orienting blocked films described herein may be 4× to 7× (or 4× to 6×, or 5× to 6.5×, or 6× to 6×). One skilled in the art without undo experimentation may determine suitable temperatures and roller speeds for each roller in a given MDO stage of film production for producing the desired stretch ratios.

The oriented films of the present disclosure may have a thickness of about 45 μm to about 75 μm (or about 45 μm to about 60 μm, or about 50 μm to about 65 μm, or about 55 μm to about 75 μm).

In the oriented films of the present disclosure, the thickness ratio between a blocking layer and the cumulative thickness of the nonblocking layers may be about 1:50 to about 1:2 (or 1:50 to about 1:25, or about 1:30 to about 1:15, or about 1:20 to about 1:2).

In the oriented films of the present disclosure when two or more different nonblocking layers are used (e.g., the first layer 120 and the second layer 122 of FIG. 1C), the thickness ratio between two nonblocking layers may be about 1:10 to about 10:1 (or about 1:7 to about 7:1, or about 1:5 to about 5:1).

The oriented films of the present disclosure may have a bending stiffness of about 2 mN*mm to about 4 mN*mm (or about 2 mN*mm to about 3.5 mN*mm, or about 2.5 mN*mm to about 4 mN*mm).

The oriented films of the present disclosure may have a machine direction force at 1% strain of about 10 N to about 20 N (or about 10 N to about 15 N, or about 13 N to about 17 N, or about 15 N to about 20 N).

The oriented films of the present disclosure may have a machine direction force at break of about 75 N to about 200 N (or about 75 N to about 150 N, or about 100 N to about 175 N, or about 150 N to about 200 N).

The oriented films of the present disclosure may have a machine direction elongation of about 150% or less (or about 15% to about 150%, or about 15% to about 50%, or about 30% to about 100%, or about 75% to about 150%).

The oriented films of the present disclosure may have total haze of less than about 20% (or about 1% to about 20%, or about 1% to about 10%, or about 5% to about 15%).

The oriented films of the present disclosure may have a gloss of about 50 gloss units or greater (or about 50 gloss units to about 90 gloss units, or about 55 gloss units to about 85 gloss units, or about 70 gloss units to about 90 gloss units).

The oriented films of the present disclosure may have a clarity of about 50% or greater (or about 50% to about 90%, or about 60% to about 80%, or about 70% to about 90%).

The oriented films of the present disclosure may be used as face stock for labels. The oriented films may be printed on before application as a label. An adhesive may be applied to at least a portion of a surface of the oriented film before application as a label.

mLLDPE

Metallocene-catalyzed linear low density polyethyene (mLLDPE) may be used in blocking layers of the various films described herein.

mLLDPEs may be a copolymer of 80 wt % to 99.9 wt % ethylene-derived units, with the balance of units derived from one or more C₃ to C₁₂ α-olefin comonomer (and in particular one or more of butene, hexene, octene; preferably one of those; and more preferably hexene). The wt % is based on total mass of ethylene-derived units plus comonomer-derived units in the polyethylene. Such polyethylenes are referred to as “flat composition distribution” in recognition that comonomer is incorporated in relatively equal amounts (by wt %) in shorter vs. longer molecular-weight chains within the polymer. These also may be referred to as “narrow-CD” or “narrow-composition-distribution” polyethylenes; or, equivalently, high-CDBI mLLDPEs. Composition distribution refers to the distribution of comonomer among polymer chains of different length (different molecular weight), and CDBI refers to Composition Distribution Breadth Index, which is defined as the weight percent of the copolymer molecules (chains) having a comonomer content within 50% of the median total molar comonomer content, and it is described in U.S. Pat. No. 5,382,630, which is hereby incorporated by reference. The CDBI of a copolymer is readily determined utilizing well known techniques for isolating individual fractions of a sample of the copolymer. One such technique is Temperature Rising Elution Fraction (TREF), as described in Wild, et al., J. Poly. Sci., Poly. Phys. Ed., vol. 20, p. 441 (1982) and U.S. Pat. No. 5,008,204, which are incorporated herein by reference. Thus, a higher value of CDBI indicates a narrow composition distribution (meaning that comonomer is distributed relatively evenly across polymer chains of different molecular weight).

The narrow-CD polyethylene may have CDBI of at least 50%, more preferably at least 60%, such as within the range from 50 to 90%, or 60 to 80%.

A mLLDPE (narrow-CD or otherwise) may more particularly have ethylene-derived content within the range from a low of any one of 80, 85, 86, 87, 87.5, 88, 90, 91, 92, 93, 94 or 95 wt % to a high of any one of 88, 90, 93, 94, 95, 96, 97, 98, 99, or 99.9 wt %; with ranges from any foregoing low to any foregoing high contemplated, provided the high end is greater than the low end (e.g., 85 to 95 wt %, such as 86 to 92 wt % ethylene-derived units; or 94 to 99 wt % ethylene-derived units). The balance is comprised of the C₃ to C₁₂ α-olefin comonomer-derived units (e.g., hexene).

The mLLDPEs (narrow-CD or otherwise) may provide reduced softening point relative to formation processes, and furthermore provide excellent sealing, optical, and mechanical properties to a film made therefrom. The mLLDPE preferably also has one or more, preferably all, of the following further properties:
Peak melting temperature within the range from 105 to 120° C., preferably 110° C. or 111° C. to 115° C. or 116° C. Peak melting temperature, also referred to herein by the shorthand “melting point” is determined by using a differential scanning calorimeter (DSC). DSC measurements can be carried out with a TA DSC8000 instrument under N₂ atmosphere with a heating/cooling rate of 10 K/min. The samples are heated from—50 to 300° C., held for 5 minutes in order to remove the previous thermal history, then cooled down to −50° C., and then heated again to 300° C.
Vicat softening temperature within the range from softening point within the range from 70° C. to 130° C., preferably 90° C. to 110° C., such as from a low of any one of 70, 75, 80, 85, 90, 95, 96, 97, 98, 99, or 100° C. to a high of any one of 100, 101, 102, 103, 104, 105, 110, 115, 120, 125, or 130° C. (with ranges from any foregoing low to any foregoing high contemplated, provided the high is greater than the low, e.g., 90° C. to 110° C. or 97° C. to 103° C.).
Melt flow index (190° C., 2.16 kg load) within the range from 0.1 to 5.0 g/10 min, such as from a low of any one of 0.1, 0.2, 0.3, 0.4, 0.5, 0.7, or 0.8 g/10 min to a high of any one of 1.0, 1.1, 1.2, 1.5, 2.0, 2.5, 3.0, 3.5, 4.0, 4.5, or 5.0 g/10 min; with ranges from any foregoing low end to any foregoing high end also contemplated.
Long chain branching index (LCB Index, also referred to herein as g′ (vis) or g′ index) greater than 0.95, preferably greater than or equal to 0.96 or 0.97.

The mLLDPE may also have one or more, preferably all of the following:
Weight average molecular weight (Mw) within the range from 45,000 to 120,000 g/mol, such as from 50,000 to 115,000 g/mol or 60,000 to 110,000 g/mol (with ranges from any foregoing low end to any foregoing high end also contemplated, e.g., 45,000 to 110,000 g/mol);
Number average molecular weight (Mn) within the range from 20,000 to 55,000 g/mol, such as within the range from 25,000; 30,000; 35,000; or 40,000 to a high of 30,000; 35,000; 40,000; 45,000; 50,000; or 55,000 g/mol, with ranges from any foregoing low end to any foregoing high end also contemplated (provided the high end is greater than the low end), e.g., from 35,000 to 55,000 g/mol;
Molecular weight distribution (Mw/Mn) within the range from 1.5 or 2.0 to 3.5 or 4; and
Density within the range from 0.905 to 0.940 g/cm³, such as within the range from a low end of any one of 0.905, 0.910, 0.911, 0.912, or 0.915 g/cm³ to a high end of any one of 0.913, 0.914, 0.915, 0.920, 0.925, 0.926, 0.928, 0.930, 0.935, or 0.940 g/cm³, with ranges from any foregoing low end to any foregoing high end contemplated (provided the high end is greater than the low end), e.g., 0.910 to 0.915 g/cm³.

Examples of suitable polyethylenes for the mLLDPE (e.g., narrow-CD mLLDPE) include EXCEED™ performance polyethylenes available from ExxonMobil Chemical Company, as well as other commercially available mLLDPEs.

The distribution and the moments of molecular weight (Mw, Mn, Mz, Mw/Mn, Mz/Mn, etc.) and the monomer/comonomer content (C₂, C₄, C₆ and/or C₈, and/or others, etc.), as well as g′ (vis), for the above-described polyethylenes as well as any other polyethylene described herein, are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10 μm Mixed-B LS columns are used to provide polymer separation. Detailed analytical principles and methods for molecular weight determinations and g′(vis) are described in paragraphs [0044]-[0051] of PCT Publication WO2019/246069A1, which are incorporated herein by reference (noting that the equation c=///referenced in Paragraph [0044] therein for concentration (c) at each point in the chromatogram, is c=βI, where β is mass constant and I is the baseline-subtracted IR5 broadband signal intensity (I)). Unless specifically mentioned, all the molecular weight moments used or mentioned in the present disclosure are determined according to the conventional molecular weight (IR molecular weight) determination methods (e.g., as referenced in Paragraphs [0044]-[0045] of the just-noted publication), noting that for the equation in such Paragraph [0044] α=0.695 and K=0.000579 (1-0.75Wt) are used, where Wt is the weight fraction for comonomer, and further noting that comonomer composition is determined by the ratio of the IR5 detector intensity corresponding to CH₂ and CH₃ channel calibrated with a series of PE and PP homo/copolymer standards whose nominal values are predetermined by NMR or FTIR (providing methyls per 1000 total carbons (CH₃/1000 TC)) as noted in Paragraph [0045] of the just-noted PCT publication). Other parameters needed can be found in the referenced passage in the WO2019/246069A1 publication, but some are included here for convenience: n=1.500 for TCB at 145° C.; I=665 nm; dn/dc=0.1048 ml/mg.

It is believed that mLLDPEs according to the above description, when employed in a film, provide excellent sealing, toughness, and puncture performance. In addition, they provide benefits to orientation processes such as the double-bubble formation process insofar as they impart relatively lower melting and softening points to the composition, helping with bubble formation and stability (particularly in combination with one or more of the other polyethylene(s), discussed below).

In particular embodiments, the mLLDPE may be deployed in a skin layer (or corresponding skin formulation), where the imparted properties just noted may be particularly suitable. However, mLLDPE may likewise be deployed in a core layer in various embodiments, and in some instances, it could be present in at least one core layer and at least one skin layer of films according to various embodiments herein.

Long-Chain-Branched mLLDPEs

Long-chain branched (LCB) mLLDPEs may be used in nonblocking layers of the various films described herein.

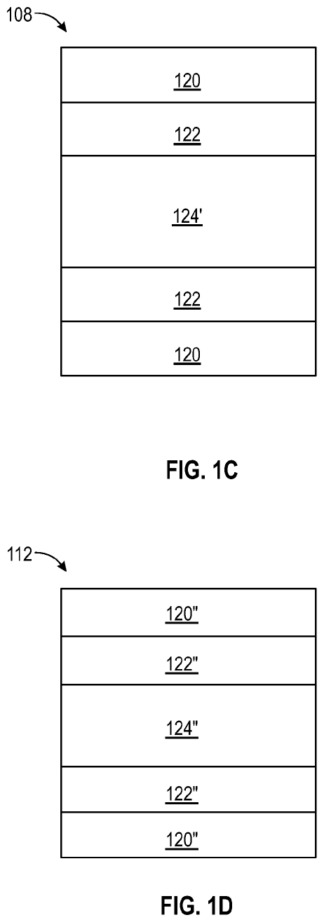

Advantageously, LCB-mLLDPEs may impart high bubble stability (e.g., in a blown film process, including in a double-bubble blown film process), preferably while still imparting suitable film performance properties. It is noted that these mLLDPEs are considered long-chain-branched as compared to other linear low-density polyethylenes, and in particular as compared to other metallocene LLDPEs; whereas their total long-chain branching will still be less than LDPEs with very high degrees of long-chain branching. This small amount of LCB can be evidenced through, e.g., a high melt index ratio (MIR) and/or particular rheology characteristics as shown through data obtained by small angle oscillatory shear (SAOS) experiments (for instance, ratio of η_{0.01}/η₁₀₀, the complex viscosity recorded at shear rates of 0.01 and 100 rad/s, respectively). Another useful parameter for indicating the presence of LCB is illustrated in FIG. 2: Van Gurp Palmen (VGP) plots. In particular, polyethylene copolymers (even LLDPE) with some LCB will exhibit an inflection point in their VGP curve, while LLDPE without any LCB present show no such inflection point. See, for example, the Enable™ brand LLDPEs, examples of LCB-mLLDPEs, in FIG. 2 (in comparison to the XP8318 LLDPE, having no LCB, also shown in FIG. 2).

Yet another useful parameter illustrating presence of some LCB can be seen in the melt index ratio. Melt index ratio (MIR) is the ratio of high load melt index (HLMI, ASTM D1238 at 190° C., 21.6 kg) to melt index (MI₂, ASTM D1238 at 190° C., 2.16 kg).

Accordingly, LCB-mLLDPEs useful for the present compositions can have one or more of the following properties (which can be useful indicia of moderate LCB):
MIR within the range from a low of any one of 20, 25, 26, 27, 28, 29, 30, or 31 to a high of any one of 40, 35, 34, 33, 32, 31, or 30 with ranges from any of the foregoing lows to any of the foregoing highs contemplated herein (e.g., 27 to 33, such as 28 to 32, or 29 to 31).
Complex shear viscosity (η*) @ 0.01 rad/see and 190° C. in the range of 5,000 to 12,000 Pa·s; or from a low of any one of 5,000; 6,000; 7,000; 8,000; 9,000; 10,000; or 11,000 Pa·s, to a high of any one of 12,000; 11,000; 10,000; 9,000; 8,000; 7,000; or 6,000 Pa·s, with ranges from any low end to any high end contemplated (e.g., 6,000 to 8,000 Pa·s).
Complex shear viscosity (η*) @ 100 rad/sec and 190° C. within the range from 900 to 2000 Pa·s; such as from a low end of any one of 900; 1,000; 1,100; or 1,200 Pa·s to a high end of any one of 1,200; 1,300; 1,400; 1,500; or 2,000 Pa·s, with ranges from any foregoing low to any foregoing high also contemplated (e.g., 1,100 to 1,300 Pa·s).
Shear thinning ratio (η*@ 0.01/100) less than 15, or in the range of 3 to 15, or 4 to 12, or 5 to 10, or 5.5 to 8.
An inflection point in a Van Gurp Palmen plot of phase angle vs. complex modulus (Pa) of the LCB-mLLDPE.

Finally, yet another indicator of LCB can be seen in the LCB index (g′ or alternatively g′vis), which for LCB-mLLDPE could be less than 1, such as within the range from 0.9 to 0.99 or 0.94 to 0.98, although still substantially higher than g′ for heavily-LCB polyethylene, such as LDPE made using free radical polymerization.

LCB-mLLDPEs, like the above-described mLLDPEs, are preferably copolymers of 80 to 99.9 wt % ethylene-derived units, with the balance derived from one or more C₃ to C₁₂ α-olefins (and in particular one or more of butene, hexene, octene; preferably one of those; and more preferably hexene). The wt % is based on total mass of ethylene-derived units plus comonomer-derived units in the polyethylene.

LCB-mLLDPEs preferably have CDBI greater than or equal to 50%, preferably greater than or equal to 70%, such as within the range from a low of any one of 50, 60, or 70% to a high of 80, 85, 90, 95, or 99%, with ranges from any foregoing low end to any foregoing high end contemplated. LCB-mLLDPEs further may have MWD (Mw/Mn) within the range from 2.5 to 5.5, such as within the range from 3 or 3.5 to 4.5 or 5.

Furthermore, LCB-mLLDPEs may have a melt flow index (190° C., 2.16 kg load) within the range from 0.1 to 0.7 g/10 min, such as within the range from a low of any one of 0.1, 0.15, 0.2, or 0.22 to a high of any one of 0.22, 0.25, 0.26, 0.27, 0.30, 0.40, 0.45, 0.50, 0.60, or 0.70 g/10 min; with ranges from any foregoing low end to any foregoing high end also contemplated (provided the high end is greater than the low end), e.g., from 0.15 to 0.30 g/10 min; or 0.15 to 0.27 g/10 min.

LCB-mLLDPEs may exhibit high stiffness and excellent processability. In addition to the properties noted above, LCB-mLLDPE may have one or more, preferably all, of the following properties:
Peak melting temperature (determined by DSC as described above) within the range from 115° C. to 135° C., preferably 120° C., 121° C., 123° C. or 125° C. to 130° C. or 133° C.;
Vicat softening temperature within the range from 110 to 130° C., such as 115° C. to 125° C., or from a low of any one of 110, 115, 118, 119, or 120° C. to a high of any one of 123, 124, 125, 127, 130, or 135° C., with ranges from any foregoing low to any foregoing high contemplated (e.g., 115° C. to 125° C.); and
Density within the range from 0.930 to 0.950 g/cm³, such as from a low of any one of 0.935, 0.936, 0.937, or 0.938 g/cm³ to a high of any one of 0.942, 0.943, 0.944, 0.945, or 0.950 g/cm³, with ranges from any forgoing low to any foregoing high contemplated herein (e.g., 0.935 to 0.945 g/cm³).

Examples of commercial LCB-mLLDPE may include, but are not limited to, ENABLE™ brand polyethylene from ExxonMobil Chemical Company, such as ENABLE™ 4002 performance polyethylene.

### High Density Polyethylene

High density polyethylene (HDPE) may be used in nonblocking layers of the various films described herein.

The HDPE may have a density of greater than or equal to 0.940 g/cm³ (or 0.940 g/cm³ to 0.970 g/cm³, or 0.945 g/cm³ to 0.965 g/cm³, 0.950 g/cm³ to 0.970 g/cm³).

The HDPE may have a melt index (190° C., 2.16 kg load) of about 0.1 g/10 min to about 1.5 g/10 min (or 0.5 g/10 min to 1.0 g/10 min).

The HDPE may have a melt index (a ratio of the melt index measured at 190° C., 21.6 kg load to the melt index measured at 190° C., 2.16 kg load) of about 35 to about 60 (or about 35 to about 50, or about 45 o about 60).

The HDPE may have a Vicat Softening temperature of about 120° C. to about 150° C. (or about 125° C. to about 135° C., or about 130° C. to about 140° C.).

A suitable HDPE may be a polyethylene homopolymer or an ethylene-α-olefin copolymer (where the α-olefin may be any of those discussed above in connection with LDPE).

A suitable HDPE may be produced by any suitable process known to those skilled in the art, for example, gas-phase fluidized bed polymerization or slurry polymerization, or a combination thereof (e.g., in the case of reactor or other bimodal HDPE compositions, which may be produced in two or more series reactors).

Nonlimiting examples of commercially available HDPE may include, but are not limited to, HTA 108 (HDPE, available from ExxonMobil), HTA 001HD5 (HDPE, available from ExxonMobil), HTA 001HP5 (HDPE, available from ExxonMobil), HTA 002HD5 (HDPE, available from ExxonMobil), the like, and any combination thereof.

### Ethylene-Based Elastomers

The ethylene-based elastomers may be a copolymer of ethylene-derived units and units derived from at least one of a C₃ to C₁₀ alpha-olefin. The ethylene-based elastomer may contain at least 85 wt % ethylene-derived units based on the weight of the ethylene-based elastomer.

The ethylene-based elastomer may have a density within a range from 0.855 g/cm³ to 0.920 g/cm³ (or from 0.860 g/cm³ to 0.905 g/cm³, or from 0.865 g/cm³ to 0.890 g/cm³).

The ethylene-based elastomer may have a CDBI greater than 60 (or greater than 80, or greater than 90), where fractions having an Mw below 15,000 g/mol are ignored when determining CDBI as described in WO 93/03093, (columns 7 and 8), as well as in Wild et al, 20 J. POLY. SCI., POLY. PHYS. ED., 441 (1982) and U.S. Pat. No. 5,008,204.

The ethylene-based elastomer may have a single melting point peak occurring in the region of 50° C. to 110° C.

The ethylene-based elastomer may have a Mw greater than 70,000 g/mol to less than 130,000 g/mol.

The ethylene-based elastomer may have a Hf of greater than 75 J/g (or 75 J/g to 130 J/g).

The ethylene-based elastomer may have a molecular weight distribution (Mw/Mn) value less than 4.0 (or from 1.1 to 3.5).

Examples include ethylene-based elastomers are sold under the trade name EXACT™ plastomers (ExxonMobil Chemical Company), or AFFINITY™ polyolefin plastomers (Dow Chemical Company).

### Propylene-Based Elastomers

The propylene-based elastomers may be a copolymer of propylene-derived units and units derived from at least one of ethylene or a C₄ to C₁₀ alpha-olefin. The propylene-based elastomer may contain at least 60 wt % propylene-derived units based on the weight of the propylene-based elastomer. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

The amount of propylene-derived units present in the propylene-based elastomer may be present in an amount from at least 60 wt %, at least 65 wt %, at least 70 wt %, at least 75 wt %, at least 80 wt %, at least 84 wt %, at least 85 wt %, at least 88 wt %, at least 90 wt %, at least 92 wt %, at least 94 wt %, at least 96 wt % or at least 98 wt % of the propylene-based elastomer. Additionally or alternatively, the amount of propylene-derived units present in the propylene-based elastomer may be present in an amount of, at most 98 wt %, at most 96 wt %, at most 94 wt %, at most 92 wt %, at most 90 wt %, at most 88 wt %, at most abut 85 wt %, at most 84 wt % or at most 80 wt % of the propylene-based elastomer. Ranges expressly disclosed include combinations of any of the above-enumerated values like 60 wt % to 98 wt %, 70 wt % to 98 wt %, 80 wt % to 98 wt %, 85 wt % to 98 wt %, 90 wt % to 98 wt %, 70 wt % to 96 wt %, 75 wt % to 96 wt %, 80 wt % to 96 wt %, 85 wt % to 96 wt %, 90 wt % to 96 wt %.

The units, or comonomers, derived from at least one of ethylene or a C₄ to C₁₀ alpha-olefin may be present in an amount of 1 wt % to 35 wt %, or 2 wt % to 35 wt %, or 5 wt % to 35 wt %, or 7 wt % to 32 wt %, or 8 wt % to 25 wt %, or 10 wt % to 25 wt %, or 12 wt % to 20 wt %, or 8 wt % to 20 wt %, or 8 wt % to 18 wt %, or 5 wt % to 20 wt %, or 5 wt % to 15 wt %, or 2 wt % to 10 wt %, or 2 wt % to 6.0 wt %, based on the weight of the propylene-based elastomer.

In preferred embodiments, the comonomer is ethylene, 1-hexene, or 1-octene. In some embodiments, the propylene-based elastomer comprises ethylene-derived units or consists essentially of units derived from propylene and ethylene, i.e., the propylene-based elastomer does not contain any other comonomer in an amount other than that typically present as impurities in the ethylene and/or propylene feedstreams used during polymerization, or in an amount that would materially affect the 1% secant flexural modulus and/or melt mass-flow rate of the propylene-based elastomer, or any other comonomer intentionally added to the polymerization process. In such embodiments, the propylene-based elastomer may comprise 2 wt % to 25 wt %, or 5 wt % to 25 wt %, or 10 wt % to 25 wt %, or 6 wt % to 22 wt %, or 12 wt % to 20 wt %, or 7 wt % to 20 wt %, or 5 wt % to 20 wt %, or 5 wt % to 15 wt %, or 8 wt % to 17 wt %, or 9 wt % to 16 wt %, or 2 wt % to wt % or 2 wt % to 6.0 wt %, ethylene-derived units based on the weight of the propylene-based elastomer.

The propylene-based elastomer may comprise more than one comonomer. Preferred embodiments of a propylene-based elastomer having more than one comonomer include propylene-ethylene-octene, propylene-ethylene-hexene, and propylene-ethylene-butene polymers. In embodiments where more than one comonomer derived from at least one of ethylene or a C₄ to C₁₀ alpha-olefin is present, the amount of one comonomer may be less than 5 wt % of the propylene-based elastomer, but the combined amount of comonomers of the propylene-based elastomer is 5 wt % or greater of the total propylene-based elastomer.

In some embodiments, the propylene-based elastomer may further comprise a diene. The optional diene may be any hydrocarbon structure having at least two unsaturated bonds wherein at least one of the unsaturated bonds is readily incorporated into a polymer. For example, the optional diene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkyliene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of diene-derived units present in the propylene-based elastomer may range from an upper limit of 15 wt %, 10 wt %, 7 wt %, 5 wt %, 4.5 wt %, 3 wt %, 2.5 wt %, or 1.5 wt %, to a lower limit of 0%, 0.1 wt %, 0.2 wt %, 0.3 wt %, 0.5 wt %, or 1 wt %, based on the total weight of the propylene-based elastomer. In some embodiments, the propylene-based elastomer does not contain any diene-derived units.

The propylene-based elastomer may have a triad tacticity of three propylene units, as measured by ¹³C NMR, of at least 75%, at least 80%, at least 82%, at least 85%, or at least 90%. Preferably, the propylene-based elastomer has a triad tacticity of 50% to 99%, 60% to 99%, 75% to 99%, or 80% to 99%. In some embodiments, the propylene-based elastomer may have a triad tacticity of 60% to 97%.

The propylene-based elastomer may have a heat of fusion (“ΔH_{f}”) of 75 J/g or less, 70 J/g or less, 50 J/g or less, or 45 J/g or less, or 35 J/g or less. The propylene-based elastomer may have a lower limit ΔH_{f} of 0.5 J/g, 1 J/g, or 5 J/g. For example, the ΔH_{f} value may be anywhere from 1.0 J/g, 1.5 J/g, 3.0 J/g, 4.0 J/g, 6.0 J/g, or 7.0 J/g, to 30 J/g, 35 J/g, 40 J/g, 50 J/g, 60 J/g, 70 J/g, or 75 J/g.

The propylene-based elastomer may have a percent crystallinity, as determined according to the DSC procedure described herein, of 2% to 65%, 0.5% to 40%, 1% to 30%, or 5% to 35%, of the crystallinity of isotactic polypropylene. The thermal energy for the highest order of propylene (i.e., 100% crystallinity) is estimated at 189 J/g. In some embodiments, the copolymer has crystallinity less than 40%, or in the range of 0.25% to 25%, or 0.5% to 22%, of isotactic polypropylene. Embodiments of the propylene-based elastomer may have a tacticity index m/r from a lower limit of 4 or 6 to an upper limit of 8 or 10 or 12. In some embodiments, the propylene-based elastomer has an isotacticity index greater than 0%, or within the range having an upper limit of 50% or 25%, and a lower limit of 3% or 10%.

The propylene-based elastomer may have a 1% secant flexural modulus, as measured according to ASTM D790-17, of at least 5.0 MPa, at least 10 MPa, at least 20 MPa, at least 30 MPa, at least 40 MPa, at least 50 MPa, at least 60 MPa, at least 70 MPa, at least 80 MPa, at least 90 MPa, at least 100 MPa, at least 125 MPa, at least 150 MPa, at least 175 MPa, at least 200 MPa, at least 225 MPa, at least 250 MPa, at least 275 MPa, at least 300 MPa, at least 325 MPa, at least 350 MPa, at least 375 MPa, at least 400 MPa, at least 425 MPa, at least 450 MPa, at least 475 MPa, or 500 MPa. Additionally or alternatively, the propylene-based elastomer may have a 1% secant flexural modulus, as measured according to ASTM D790-17, of at most 500 MPa, at most 475 MPa, at most 450 MPa, at most 425 MPa, at most 400 MPa, at most 375 MPa, at most 350 MPa, at most 325 MPa, at most 300 MPa, at most 275 MPa, at most 250 MPa, at most 225 MPa, at most 200 MPa, at most 175 MPa, at most 150 MPa, at most 125 MPa, at most 100 MPa, at most 90 MPa, at most 80 MPa, at most 70 MPa, at most 60 MPa, at most 50 MPa, at most 40 MPa, at most 30 MPa, at most 20 MPa, at most 10 MPa, or 5.0 MPa. Ranges expressly disclosed include combinations of any of the above-enumerated values like 5.0 MPa to 500 MPa, 5.0 to 250 MPa, 5.0 MPa to 100 MPa, 5.0 MPa to 50 MPa, 5 MPa to 20 MPa, 20 MPa to 500 MPa, 20 MPa to 250 MPa, 20 MPa to 100 MPa, 20 MPa to 50 MPa, 40 MPa to 500 MPa, 40 MPa to 250 MPa, 40 to 100 MPa, 40 MPa to 70 MPa, 40 MPa to 60 MPa, 50 MPa to 500 MPa, 50 MPa to 250 MPa, 50 MPa to 100 MPa, 100 MPa to 500 MPa, 100 MPa to 250 MPa, 200 MPa to 500 MPa, 200 MPa to 450 MPa, 200 MPa to 400 MPa, 200 MPa to 350 MPa, 200 MPa to 300 MPa, 300 MPa to 500 MPa, 300 MPa to 450 MPa, 300 MPa to 400 MPa, 300 MPa to 350 MPa, 350 MPa to 500 MPa, 350 MPa to 450 MPa, 350 MPa to 400 MPa.

The propylene-based elastomer may have a melt flow index (2.16 kg load at 230° C.) of at least 1 g/10 min, at least 15 g/10 min, at least 50 g/10 min, at least 100 g/10 min, at least 1,000 g/10 min, at least 2,500 g/10 min, at least 5,000 g/10 min, at least 7,500 g/10 min, at least 10,000 g/10 min, at least 12,500 g/10 min, at least 15,000 g/10 min, at least 17,500 g/10 min, at least 20,000 g/10 min, at least 22,500 g/10 min, at least 25,000 g/10 min, at least 27,500 g/10 min or 30,000 g/10 min. Additionally or alternatively, the propylene-based elastomer may have a melt flow index (2.16 kg load at 230° C.) of at most 30,000 g/10 min, at most 27,500 g/10 min, at most 25,000 g/10 min, at most 22,500 g/10 min, at most 20,000 g/10 min, at most 17,500 g/10 min, at most 15,000 g/10 min, at most 12,500 g/10 min, at most 10,000 g/10 min, at most 7,500 g/10 min, at most 5,000 g/10 min, at most 2,500 g/10 min, at most 1,000 g/10 min, at most 100 g/10 min, at most 50 g/10 min, at most 15 g/10 min, or 5 g/10 min. Ranges expressly disclosed include combinations of any of the above-enumerated values like 1 g/10 min to 5 g/10 min, 1 g/10 min to 15 g/10 min, 5 g/10 min to 30,000 g/10 min, 5 g/10 min to 20,000 g/10 min, 5 g/10 min to 10,000 g/10 min, 5 g/10 min to 1,000 g/10 min, 5 g/10 min to 100 g/10 min, 5 g/10 min to 50 g/10 min, 5 g/10 min to 15 g/10 min, 1,000 g/10 min to 30,000 g/10 min, 1,000 g/10 min to 20,000 g/10 min, 1,000 g/10 min to 10,000 g/10 min, 1,000 g/10 min to 5,000 g/10 min, 10,000 g/10 min to 30,000 g/10 min, 10,000 g/10 min to 20,000 g/10 min, 10,000 g/10 min to 15,000 g/10 min, 20,000 g/10 min to 30,000 g/10 min, 20,000 g/10 min to 27,500 g/10 min, 22,500 g/10 min to 30,000 g/10 min, 22,500 g/10 min to 27,500,000 g/10 min, 22,500 g/10 min to 25,000 g/10 min.

The propylene-based elastomer may have a melting point temperature (Tₘ) of 105° C. or less, 100° C. or less, 90° C. or less, 80° C. or less, or 70° C. or less. In some embodiments, the propylene-based elastomer has a Tₘ of 25° C. to 105° C., 60° C. to 105° C., 70° C. to 105° C., or 90° C. to 105° C.

The propylene-based elastomer may have a density of 0.850 g/cm³ to 0.920 g/cm³, or 0.860 g/cm³ to 0.890 g/cm³.

The propylene-based elastomer may have an elongation at break, as measured per ASTM D638-14, of at least 200%, at least 500%, at least 1000%, at least 1500%, at least 2000% or at least 3000%.

The propylene-based elastomer may have a weight average molecular weight (Mw) of 5,000 g/mole to 5,000,000 g/mole, 10,000 g/mole to 1,000,000 g/mole, 20,000 g/mole to 750,000 g/mole, 30,000 g/mole to 400,000 g/mole.

The propylene-based elastomer may have a number average molecular weight (Mn) of 2,500 g/mole to 250,000 g/mole, 10,000 g/mole to 250,000 g/mole, or 25,000 g/mole to 200,000 g/mole.

The propylene-based elastomer may have a z-average molecular weight (Mz) of 10,000 g/mole to 7,000,000 g/mole, 80,000 g/mole to 700,000 g/mole, or 100,000 g/mole to 500,000 g/mole.

The propylene-based elastomer may have a molecular weight distribution (Mw/Mn) of 1.5 to 20, or 1.5 to 15, preferably 1.5 to 5, and more preferably 1.8 to 3, and most preferably 1.8 to 2.5.

Various propylene-based elastomers having any combination of the above-described properties are contemplated herein.

The propylene-based elastomer may comprise copolymers prepared according to the procedures described in WO 02/36651, U.S. Pat. No. 6,992,158, and/or WO 00/01745, the contents of which are incorporated herein by reference. Preferred methods for producing the propylene-based elastomer may be found in U.S. Pat. Nos. 7,232,871 and 6,881,800, the contents of which are incorporated herein by reference. The propylene-based elastomer described herein are not limited by any particular polymerization method for preparing the propylene-based elastomer, and the polymerization processes are not limited by any particular type of reaction vessel.

Suitable propylene-based elastomers may be available commercially under the trade names VISTAMAXX™ (available from ExxonMobil Chemical Company) (e.g., VISTAMAXX™ 3000, VISTAMAXX™ 3588FL, VISTAMAXX™ 6102, VISTAMAXX™ 8880), VERSIFY™ (available from The Dow Chemical Company), certain grades of TAFMER™ XM or NOTIO™ (available from Mitsui Company), and certain grades of SOFTEL™ (available from Basell Polyolefins). The particular grade(s) of commercially available propylene-based elastomer suitable for use in the invention can be readily determined using methods commonly known in the art.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### Additional Embodiments

Embodiment 1. A method comprising: blowing a film comprising a first layer, a second layer, and a third layer, wherein the first layer comprises a long chain branched metallocene linear low density polyethylene (LCB-mLLDPE), wherein the second layer comprises a high density polyethylene, and wherein the third layer comprises 0 wt % to about 90 wt % of a metallocene linear low density polyethylene (mLLDPE) and about 10 wt % to 100 wt % of an ethylene-based elastomer and/or a propylene-based elastomer; blocking the film with the third layer as a blocking layer to yield a blocked film; and orienting the blocked film in a machine direction to produce an oriented film, wherein the oriented film has a polyethylene content of about 90 wt % or greater.

Embodiment 2. The method of Embodiment 1, wherein the second layer is between and abutting each of the first layer and the third layer.

Embodiment 3. The method of Embodiment 1, wherein the first layer is between and abutting each of the second layer and the third layer.

Embodiment 4. The method according to any of Embodiments 1-3, wherein the first layer consists essentially of (or, alternatively, consists of) the LCB-mLLDPE.

Embodiment 5. The method according to any of Embodiments 1-4, wherein the second layer consists essentially of (or, alternatively, consists of) the high density polyethylene.

Embodiment 6. The method according to any of Embodiments 1-5, wherein the oriented film has a cumulative amount of the LCB-mLLDPE and the high density polyethylene of about 70 wt % or greater.

Embodiment 7. The method according to any of Embodiments 1-6, wherein the propylene-based elastomer is present and has a density of about 0.850 g/cm³ to about 0.920 g/cm³.

Embodiment 8. The method according to any of Embodiments 1-7, wherein the propylene-based elastomer is present and has a melt flow index measure at 230° C. and 2.16 kg load of about 1 g/cm³ to about 10 g/cm³.

Embodiment 9. The method according to any of Embodiments 1-8, wherein the propylene-based elastomer is present and has an ethylene content of about 1 wt % to about 35 wt %.

Embodiment 10. The method according to any of Embodiments 1-9, wherein the mLLDPE is a copolymer of ethylene and 1-hexene.

Embodiment 11. The method according to any of Embodiments 1-10, wherein the LCB-mLLDPE is a copolymer of ethylene and 1-hexene.

Embodiment 12. The method according to any of Embodiments 1-11, wherein high density polyethylene is a homopolymer.

Embodiment 13. The method according to any of Embodiments 1-12, wherein the blocked film has a thickness of about 200 μm to about 450 μm.

Embodiment 14. The method according to any of Embodiments 1-13, wherein the oriented film has a thickness of about 45 μm to about 75 μm.

Embodiment 15. The method according to any of Embodiments 1-14, wherein the orienting of the film is performed at a stretch ratio of about 4 to about 7.

Embodiment 16. An oriented film comprising: a first layer comprising a long chain branched metallocene linear low density polyethylene (LCB-mLLDPE); a second layer comprising a high density polyethylene; a third layer comprising 0 wt % to about 90 wt % of a metallocene linear low density polyethylene (mLLDPE) and about 10 wt % to 100 wt % of an ethylene-based elastomer and/or a propylene-based elastomer, wherein the third layer does not form a surface of the oriented film; wherein the oriented film has a polyethylene content of about 90 wt % or greater; and wherein the oriented film has a uniaxially, machine orientation.

Embodiment 17. The film of claim 16, wherein first layer consists essentially of (or, alternatively, consists of) the LCB-mLLDPE.

Embodiment 18. The method according to any of Embodiments 16-17, wherein second layer consists essentially of (or, alternatively, consists of) the high density polyethylene.

Embodiment 19. The method according to any of Embodiments 16-18, wherein the oriented film has a cumulative amount of the LCB-mLLDPE and the high density polyethylene of about 70 wt % or greater.

Embodiment 20. A method comprising: blowing a film comprising a first layer and a second layer, wherein the first layer comprises a long chain branched metallocene linear low density polyethylene (LCB-mLLDPE) and/or a high density polyethylene, and wherein the second layer comprises 0 wt % to about 90 wt % of a metallocene linear low density polyethylene (mLLDPE) and about 10 wt % to 100 wt % of an ethylene-based elastomer and/or a propylene-based elastomer; blocking the film with the second layer as a blocking layer to yield a blocked film; and orienting the blocked film in a machine direction to produce an oriented film, wherein the oriented film has a polyethylene content of about 90 wt % or greater.

Embodiment 21. An oriented film comprising: a first layer comprising a long chain branched metallocene linear low density polyethylene (LCB-mLLDPE) and/or a high density polyethylene; a second layer comprising 0 wt % to about 90 wt % of a metallocene linear low density polyethylene (mLLDPE) and about 10 wt % to 100 wt % of an ethylene-based elastomer and/or a propylene-based elastomer, wherein the second layer does not form a surface of the oriented film; wherein the oriented film has a polyethylene content of about 90 wt % or greater; and wherein the oriented film has a uniaxially, machine orientation.

To facilitate a better understanding of the embodiments of the present invention, the following examples of preferred or representative embodiments are given. In no way should the following examples be read to limit, or to define, the scope of the invention.

### Examples

Four films were prepared according to the following procedure.

Film 1 (comparative)—Using a commercially available blown film machine, a 900 mm wide, 5-layer film was coextruded using a die diameter of 250 mm and an output of 200 kg/h. The layers, in order, were (1) 70 wt % LD 100BW (low density polyethylene, available from ExxonMobil) blended with 30 wt % HTA 108 (high density polyethylene, available from Exxon Mobil), (2) 70 wt % LD 100BW blended with 30 wt % HTA 108, (3) 55 wt % LD 100BW blended with 45 wt % DOWLEX 5538 (medium density polyethylene, available from Dow), (4) 70 wt % LD 100BW blended with 30 wt % HTA 108, and (5) 70 wt % LD 100BW blended with 30 wt % HTA 108. The relative layer thicknesses were 1:1:4:1:1.

Film 2 (comparative)—A commercially available 80 μm transparent polyethylene face stock suitable for use in labels.

Film 3 (inventive)—Using a commercially available blown film machine, 5-layer film was coextruded using a die diameter of 250 mm at an output of 200 kg/h. The layers, in order, were (1) 100 wt % ENABLE™ 4002MC (LCB-mLLDPE, available from ExxonMobil), (2) 100 wt % HTA 108, (3) 100 wt % ENABLE™ 4002MC, (4) 100 wt % HTA 108, and (5) 80 wt % EXCEED™ 1012MA blended with 20 wt % VISTAMAXX™ 6102FL (propylene-based elastomer, available from ExxonMobil). The relative layer thicknesses were 1.5:2.5:5.5:2.5:1. The total thickness was about 150 μm. The blown film was blocked to produce a 300 μm thick film with layers (1), (2), (3), (4), (5 doubled), (4), (3), (2), (1). The blocked film was then uniaxially oriented in the machine direction using a commercially available MDO unit that includes preheating, drawing, annealing, and cooling section. For the orienting process, the preheating was performed at about 114° C., the stretching was performed at about 122° C., and the annealing and cooling was performed at about 114° C. down to about 30° C. The stretch ratio was about 5.4.

Film 4 (inventive)—The same procedure as Film 3 was used but with a stretch ratio of about 5.0.

The properties of the four films are provided in Table 1. In Table 1, Clarity is reported as the measurement of regular transmitted light that is deflected less than 0.1 degrees from the axis of the incident light. The film was placed in the film sample holder, and gently held against the left wall of the measuring compartment. It was confirmed visually that the sample was free from obvious flaws that may affect results, and neither wrinkled nor stretched. Haze is defined as the percentage of transmitted light passing through the film that is deflected by more than 2.5°. The test sample was cut out across the web per tested material/structure, using a pair of scissors, into a sample large enough to cover the microscope slide. Gloss is defined as the light reflectance property of plastic film or sheeting at a 45° angle incident beam. When measuring the gloss of a blown film or sheet, the specimen was cut in such a way that the whole surrounded area of the bubble or sheet was representatively measured. Bending stiffness factor is determined by measurement that is related to the cantilever beam method that measures the force required to flex a strip to a certain angle. In this test the sample is vertically clamped at one end while the force is applied to the free end of the sample normal to its plane (two point bending). Specimen width is 38 mm. The testing speed is 30°/min (18.33 mm/min) upon reaching the pre-load and 30°/min (18.33 mm/min) for the actual test. Finally, machine direction force at 1% strain, machine direction force at break, and machine direction elongation are determined using a similar test film specimen and similar progression of testing to obtain the relevant respective measurement. The specimen of this test is rectangular in shape, 15 mm in width and the initial distance between the grips is 50 mm. This test method employs a constant rate of separation of the grips holding the ends of the test specimen. The load is measured by means of a load cell and the deformation is measured by means of the cross-head position. No additional extensometer is used in this test. The testing speed is 5 mm/min upon reaching the pre-load. 5 mm/min to measure 1% Secant modulus. (force at 1% strain) and 500 mm/min to measure break point (force at break).

TABLE 1

| | Film 1 | Film 2 | Film 3 | Film 4 |
|---|---|---|---|---|
| | (compar- | (compar- | (inven- | (inven- |
| | ative) | ative) | tive) | tive) |
| Thickness (μm) | 85 | 80 | 55 | 60 |
| Bending | 2.86 | 2.44 | 2.44 | 3.03 |
| Stiffness Factor | | | | |
| (mN · mm) | | | | |
| MD force at 1% | 5 | 8 | 13 | 15 |
| strain (N) | | | | |
| MD force at | 32 | 19 | 121 | 153 |
| break (N) | | | | |
| MD Elongation | 535 | 79 | 26 | 29 |
| (%) | | | | |
| Total Haze (%) | 29.4 | 27.6 | 4.8 | 6.6 |
| Gloss (GU) | 33.4 | 49.6 | 78.0 | 56.4 |
| Clarity (%) | 13.7 | 49.0 | 69.0 | 70.7 |

Films 3 and 4 have superior optical properties comparing to reference samples Films 1 and 2 including a significant improvement in haze, gloss, and clarity. These improved optical properties translate to label with superior appearance.

Further, Films 3 and 4 show comparable bending stiffness to reference samples Films 1 and 2 even though Films 3 and 4 are down-gauged 25-30% in thickness. Maintaining the bending stiffness may allow for good label printing and high-speed labelling. Advantageously, because Films 3 and 4 are thinner, the label would contribute less polymer to applications.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
blowing a film comprising a first layer, a second layer, and a third layer,
wherein the first layer comprises a long chain branched metallocene linear low density polyethylene (LCB-mLLDPE),
wherein the second layer comprises a high density polyethylene, and
wherein the third layer comprises 0 wt % to 90 wt % of a metallocene linear low density polyethylene (mLLDPE) and 10 wt % to 100 wt % of an ethylene-based elastomer and/or a propylene-based elastomer;
blocking the film with the third layer as a blocking layer to yield a blocked film; and
orienting the blocked film in a machine direction to produce an oriented film, wherein the oriented film has a polyethylene content of 90 wt % or greater.

2. The method of claim 1, wherein the second layer is between and abutting each of the first layer and the third layer.

3. The method of claim 1, wherein the first layer is between and abutting each of the second layer and the third layer.

4. The method of claim 1, wherein first layer consists essentially of the LCB-mLLDPE.

5. The method of claim 1, wherein second layer consists essentially of the high density polyethylene.

6. The method of claim 1, wherein the oriented film has a cumulative amount of the LCB-mLLDPE and the high density polyethylene of 70 wt % or greater.

7. The method of claim 1, wherein the propylene-based elastomer is present and has any ethylene-derived content of 1 to 35 wt % on the basis of mass of the propylene-based elastomer, and furthermore has one or both of: a density of 0.850 g/cm³ to 0.920 g/cm³ and a melt flow index measure at 230° C. and 2.16 kg load of 1 g/cm³ to 10 g/cm³.

8. The method of claim 1, wherein the mLLDPE is a copolymer of ethylene and 1-hexene.

9. The method of claim 1, wherein the LCB-mLLDPE is a copolymer of ethylene and 1-hexene.

10. The method of claim 1, wherein the blocked film has a thickness of 200 μm to 450 μm.

11. The method of claim 10, wherein the oriented film has a thickness of 45 μm to 75 μm.

12. The method of claim 1, wherein the orienting of the film is performed at a stretch ratio of 4 to 7.

13. An oriented film comprising:
a first layer comprising a long chain branched metallocene linear low density polyethylene (LCB-mLLDPE);
a second layer comprising a high density polyethylene;
a third layer comprising 0 wt % to 90 wt % of a metallocene linear low density polyethylene (mLLDPE) and 10 wt % to 100 wt % of an ethylene-based elastomer and/or a propylene-based elastomer, wherein the third layer does not form a surface of the oriented film;
wherein the oriented film has a polyethylene content of 90 wt % or greater; and
wherein the oriented film has a uniaxially, machine orientation.

14. The oriented film of claim 13, wherein first layer consists of the LCB-mLLDPE.

15. The oriented film of claim 13, wherein second layer consists of the high density polyethylene.

16. The oriented film of claim 13, wherein the oriented film has a cumulative amount of the LCB-mLLDPE and the high density polyethylene of 70 wt % or greater.

17. A method comprising:
blowing a film comprising a first layer and a second layer,
wherein the first layer comprises a long chain branched metallocene linear low density polyethylene (LCB-mLLDPE) and/or a high density polyethylene, and
wherein the second layer comprises 0 wt % to 90 wt % of a metallocene linear low density polyethylene (mLLDPE) and 10 wt % to 100 wt % of an ethylene-based elastomer and/or a propylene-based elastomer;
blocking the film with the second layer as a blocking layer to yield a blocked film; and
orienting the blocked film in a machine direction to produce an oriented film, wherein the oriented film has a polyethylene content of 90 wt % or greater.

18. An oriented film comprising:
a first layer comprising a long chain branched metallocene linear low density polyethylene (LCB-mLLDPE) and/or a high density polyethylene;
a second layer comprising 0 wt % to 90 wt % of a metallocene linear low density polyethylene (mLLDPE) and 10 wt % to 100 wt % of an ethylene-based elastomer and/or a propylene-based elastomer, wherein the second layer does not form a surface of the oriented film;
wherein the oriented film has a polyethylene content of 90 wt % or greater; and
wherein the oriented film has a uniaxially, machine orientation.
